(19) United States
(12) Patent Application Publication
(10) Pub. No.: US 2017/0032247 A1
(43) Pub. Date: Feb. 2, 2017

(54) MEDIA CLASSIFICATION

(71) Applicant: QUALCOMM Incorporated, San Diego, CA (US)

(72) Inventors: Henok Tefera TADESSE, San Diego, CA (US); Avijit CHAKRABORTY, San Diego, CA (US); David Jonathan JULIAN, San Diego, CA (US); Henricus Meinardus STOKMAN, Amsterdam (NL); Ork DE ROOIJ, Utrecht (NL); Koen Erik Adriaan VAN DE SANDE, Breukelen (NL); Venkata Sreekanta Reddy ANNAPUREDDY, San Diego, CA (US)

(21) Appl. No.: 14/859,082

(22) Filed: Sep. 18, 2015

Related U.S. Application Data
(60) Provisional application No. 62/199,865, filed on Jul. 31, 2015.

(51) Int. Cl. G06N 3/08; G06N 3/04; G06N 99/00

(52) U.S. Cl. CPC G06N 3/088; G06N 99/005; G06N 3/04

(57) ABSTRACT

Multi-label classification is improved by determining thresholds and/or scale factors. Selecting thresholds for multi-label classification includes sorting a set of label scores associated with a first label to create an ordered list. Precision and recall values are calculated corresponding to a set of candidate thresholds from score values. The threshold is selected from the candidate thresholds for the first label based on target precision values or recall values. A scale factor is also selected for an activation function for multi-label classification where a metric of scores within a range is calculated. The scale factor is adjusted when the metric of scores are not within the range.

### CROSS-REFERENCE TO RELATED APPLICATION

The present application claims the benefit of U.S. Provisional Patent Application No. 62/199,865, filed on Jul. 31, 2015, and titled “MEDIA CLASSIFICATION,” the disclosure of which is expressly incorporated by reference herein in its entirety.

### BACKGROUND

Field

Certain aspects of the present disclosure generally relate to machine learning and, more particularly, to improving systems and methods for the classification of media, and in particular for labeling media files, including picture files.

Background

An artificial neural network, which may comprise an interconnected group of artificial neurons (e.g., neuron models), is a computational device or represents a method to be performed by a computational device.

Convolutional neural networks are a type of feed-forward artificial neural network. Convolutional neural networks may include collections of neurons that each have a receptive field and that collectively tile an input space. Convolutional neural networks (CNNs) have numerous applications. In particular, CNNs have broadly been used in the area of pattern recognition and classification.

Deep learning architectures, such as deep belief networks and deep convolutional networks, are layered neural networks architectures in which the output of a first layer of neurons becomes an input to a second layer of neurons, the output of a second layer of neurons becomes and input to a third layer of neurons, and so on. Deep neural networks may be trained to recognize a hierarchy of features and so they have increasingly been used in object recognition applications. Like convolutional neural networks, computation in these deep learning architectures may be distributed over a population of processing nodes, which may be configured in one or more computational chains. These multi-layered architectures may be trained one layer at a time and may be fine-tuned using back propagation.

Other models are also available for object recognition. For example, support vector machines (SVMs) are learning tools that can be applied for classification. Support vector machines include a separating hyperplane (e.g., decision boundary) that categorizes data. The hyperplane is defined by supervised learning. A desired hyperplane increases the margin of the training data. In other words, the hyperplane should have the greatest minimum distance to the training examples.

Although these solutions achieve excellent results on a number of classification benchmarks, their computational complexity can be prohibitively high. Additionally, training of the models may be challenging.

### SUMMARY

In one aspect, a method of selecting thresholds for multi-label classification is disclosed. The method includes sorting a set of label scores associated with a first label to create an ordered list. The method also includes calculating, from a plurality of score values, precision values and recall values corresponding to a set of candidate thresholds. The method also includes selecting a threshold from the candidate thresholds for the first label based at least in part on a target precision value or a target recall value.

Another aspect discloses a method of selecting a scale factor for an activation function for multi-label classification. The method includes calculating a metric of scores within a range, and adjusting the scale factor when the metric of scores are not within the range.

In another aspect, an apparatus for selecting thresholds for multi-label classification in wireless communication is disclosed. The apparatus includes means for sorting a set of label scores associated with a first label to create an ordered list. The apparatus also includes means for calculating, from a plurality of score values, precision values and recall values corresponding to a set of candidate thresholds. The apparatus also includes means for selecting a threshold from the candidate thresholds for the first label based at least in part on a target precision value or a target recall value.

Another aspect discloses an apparatus for selecting a scale factor for an activation function for multi-label classification. The apparatus includes means for calculating a metric of scores within a range, and means for adjusting the scale factor when the metric of scores are not within the range.

In another aspect, an apparatus for selecting thresholds for multi-label classification in wireless communication is disclosed. The apparatus has a memory and at least one processor coupled to the memory. The processor(s) is configured to sort a set of label scores associated with a first label to create an ordered list. The processor(s) is also configured to calculate, from a plurality of score values, precision values and recall values corresponding to a set of candidate thresholds. The processor(s) is also configured to select a threshold from the candidate thresholds for the first label based at least in part on a target precision value or a target recall value.

Another aspect discloses an apparatus for selecting a scale factor for an activation function in wireless communication. The apparatus has a memory and at least one processor coupled to the memory. The processor(s) is configured to calculate a metric of scores within a range, and to adjust the scale factor when the metric of scores are not within the range.

In another aspect, a non-transitory computer-readable medium for selecting thresholds for multi-label classification is disclosed. The non-transitory computer-readable medium has non-transitory program code recorded thereon which, when executed by the processor(s), causes the processor(s) to perform operations of sorting a set of label scores associated with a first label to create an ordered list. The program code also causes the processor(s) to calculate, from a plurality of score values, precision values and recall values corresponding to a set of candidate thresholds. The program code also causes the processor(s) to select a threshold from the candidate thresholds for the first label based at least in part on a target precision value or a target recall value.

Another aspect discloses a non-transitory computer-readable medium for selecting a scale factor for an activation function. The non-transitory computer-readable medium has non-transitory program code recorded thereon which, when executed by the processor(s), causes the processor(s) to perform operations of calculating a metric of scores within a range and adjusting the scale factor when the metric of scores are not within the range.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a block diagram illustrating an exemplary software architecture that may modularize artificial intelligence (AI) functions in accordance with aspects of the present disclosure.

FIG. 5 is a block diagram illustrating the run-time operation of an AI application on a smartphone in accordance with aspects of the present disclosure.

FIG. 6 is a block diagram illustrating an exemplary binary classification process.

FIG. 7 is a diagram illustrating concepts of precision and recall.

FIG. 8A is a diagram illustrating an overall example of a classification process in accordance with aspects of the present disclosure.

FIG. 8B is a block diagram illustrating an exemplary slope selection function of the classification process in accordance with aspects of the present disclosure.

FIG. 8C is a block diagram illustrating an exemplary threshold selection function of the classification process in accordance with aspects of the present disclosure.

FIG. 9 is a graph illustrating scores for a label in accordance with aspects of the present disclosure.

FIG. 10 is a graph illustrating threshold selection utilizing F measure in accordance with aspects of the present disclosure.

FIG. 11 is a flow diagram illustrating a method for selecting thresholds for multi-label classification in accordance with aspects of the present disclosure.

FIG. 12 is a flow diagram illustrating a method for selecting a scale factor for an activation function in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Aspects of the present disclosure are directed to a system and method for labeling media files. A database of media files may associate each stored media file with one or more labels. Further, a function computes a score for each label based on a media file. For instance, for a photo of a boat in a lake, the function may compute high scores for the labels “boat” and “lake” and may compute low scores for the remaining labels in the database (e.g., “car” and “barn”). The function may be a neural network and the scores may be the activation levels of the output layer of the neural network.

One aspect of the present disclosure is directed to a method of selecting classifier thresholds for the labeling system on a label-by-label basis. For the example of an image of a boat in a lake, the computed scores for “boat” may be 0.8 and “lake” may be 0.9. It may be determined separately that images in the database actually having a boat in them (and are labeled as such) reliably have a score of 0.6 or higher, and that images containing a lake in them (and are labeled as such) reliably have a score of 0.8 or higher. This means an image in the database for which the function (neural network) computes a score of 0.7 for “lake” is less likely than not to contain a lake, while an image with a computed score of 0.7 for “boat” is more likely than not to contain a boat. This information about the database may then be applied to set different thresholds for the classifier system on a per-label basis. In the example, the threshold for “boat” may be set at 0.6 and the threshold for “lake” may be set at 0.8.

Another aspect of the present disclosure is directed to modifications of the calculation of the score in the final layer of a neural network. Across the database of images, the original function (neural network) may calculate a set of scores for a given label that may be characterized as having a very narrow distribution. For example, all of the values may fall between 0.7 and 0.9, when the allowable range is between −1.0 and 1.0. Because of this, the threshold setting operation disclosed above may not provide enough generalization to new images. For example, if images of a lake tend to be scored at values of 0.8-0.9, but images not containing a lake frequently have computed scores for lake between 0.75-0.79, the performance of the labeling system will be very sensitive to the exact placement of the threshold at 0.8.

Furthermore, the function (neural network) may be expected to compute scores for new lake-containing images just below 0.8, due to normal variations in images. Similarly, new images not containing a lake may have computed scores just above 0.8. Therefore, setting the threshold for “lake” at 0.8 may yield many false-negative and false-positive results. To alleviate this sensitivity, aspects of the present disclosure are directed to a modification of the activation function for the final layer of the neural network. As a consequence of this modification, the distribution of scores for a given label may have a broader, more uniform distribution across the distribution of images. Aspects of the present disclosure provide improved generalization because the computed scores of positive and negative examples may be more spread apart.

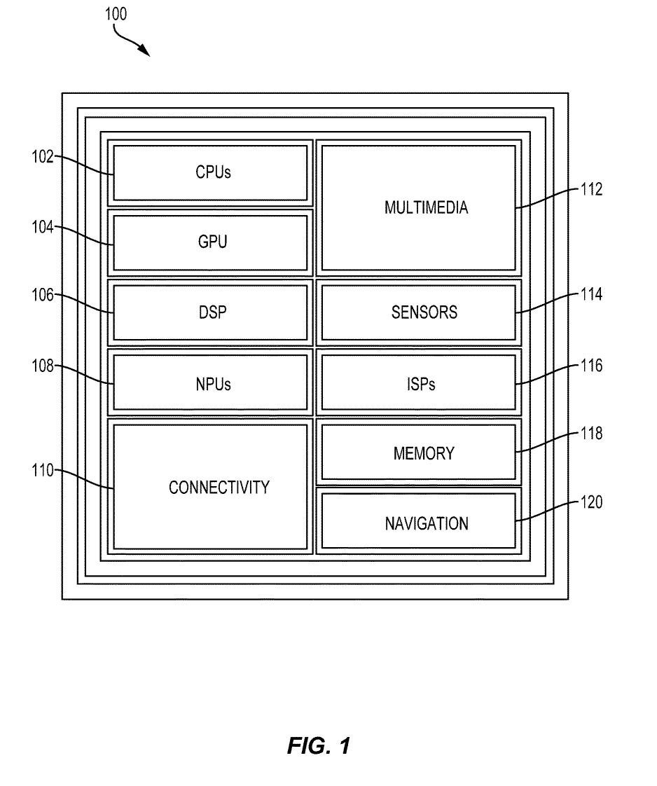

FIG. 1 illustrates an example implementation of the aforementioned labeling of media files using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system.

The SOC may be based on an ARM instruction set. In an aspect of the present disclosure, the instructions are loaded into at least one processor, such as a general-purpose processor 102, which is couple to a memory. The instructions may comprise code for sorting a set of label scores associated with a first label to create an ordered list. The instructions loaded into the general-purpose processor 102 may also comprise code for calculating precision values and recall values corresponding to a set of candidate thresholds from a set of score values. Additionally, the instructions loaded into the general-purpose processor 102 may also comprise code for selecting a threshold from the candidate thresholds for the first label based on a target precision value or a target recall value.

In another aspect of the present disclosure, the instructions loaded into the general-purpose processor 102 may comprise code for calculating a metric of scores within a range. Additionally, the instructions loaded into the general-purpose processor 102 may comprise code for adjusting the scale factor when the metric of scores are not within the range.

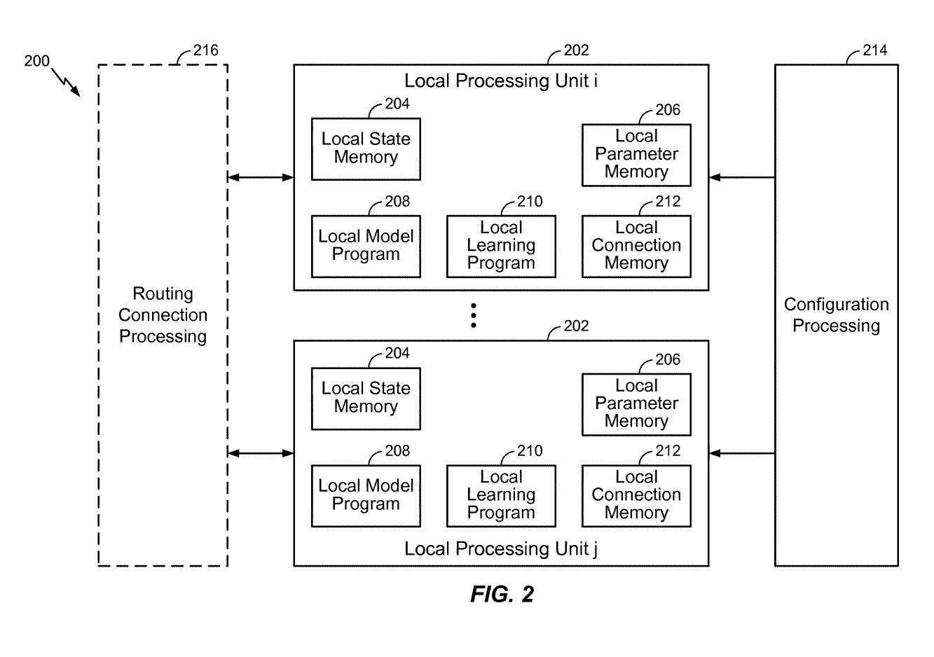

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize simple features, such as edges, in the input stream. If presented with auditory data, the first layer may learn to recognize spectral power in specific frequencies. The second layer, taking the output of the first layer as input, may learn to recognize combinations of features, such as simple shapes for visual data or combinations of sounds for auditory data. Higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer is communicated to another neuron in the same layer. A recurrent architecture may be helpful in recognizing patterns that unfold in time. A connection from a neuron in a given layer to a neuron in a lower layer is called a feedback (or top-down) connection. A network with many feedback connections may be helpful when the recognition of a high-level concept may aid in discriminating the particular low-level features of an input.

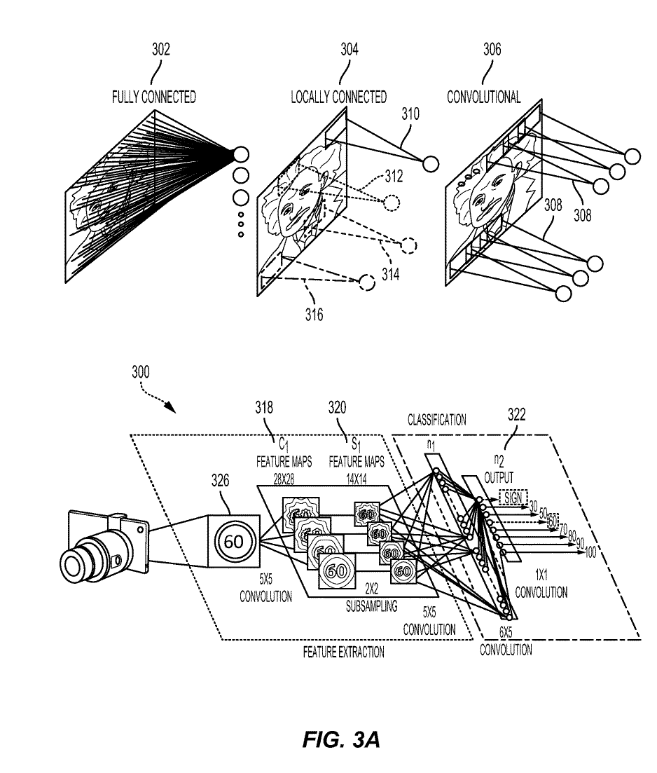

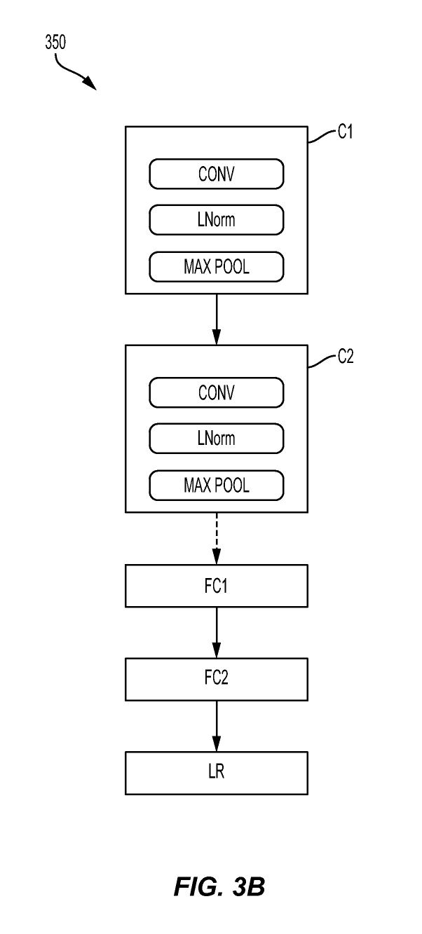

Referring to FIG. 3A, the connections between layers of a neural network may be fully connected 302 or locally connected 304. In a fully connected network 302, a neuron in a given layer may communicate its output to every neuron in the next layer. Alternatively, in a locally connected network 304, a neuron in a given layer may be connected to a limited number of neurons in the next layer. A convolutional network 306 may be locally connected, and is furthermore a special case in which the connection strengths associated with each neuron in a given layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A DCN may be trained with supervised learning. During training, a DCN may be presented with an image 326, such as a cropped image of a speed limit sign, and a “forward pass” may then be computed to produce an output 328. The output 328 may be a vector of values corresponding to features such as “sign,” “60,” and “100.” The network designer may want the DCN to output a high score for some of the neurons in the output feature vector, for example the ones corresponding to “sign” and “60” as shown in the output 328 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To properly adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 328 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318, 320, and 322, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled 324, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

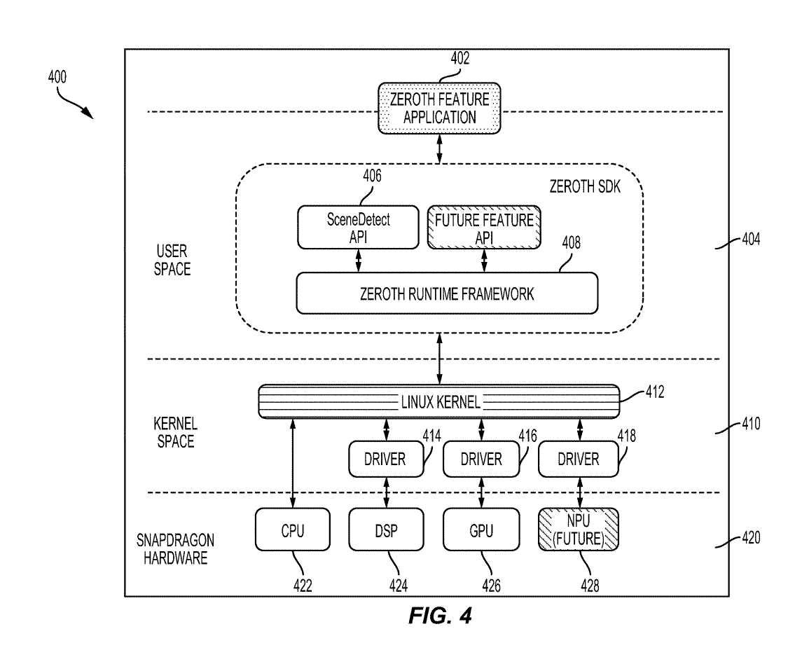

FIG. 4 is a block diagram illustrating an exemplary software architecture 400 that may modularize artificial intelligence (AI) functions. Using the architecture, applications 402 may be designed that may cause various processing blocks of an SOC 420 (for example a CPU 422, a DSP 424, a GPU 426 and/or an NPU 428) to perform supporting computations during run-time operation of the application 402.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a deep neural network configured to provide scene estimates based on video and positioning data, for example.

A run-time engine 408, which may be compiled code of a Runtime Framework, may be further accessible to the AI application 402. The AI application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the deep neural network may be configured to run on a combination of processing blocks, such as a CPU 422 and a GPU 426, or may be run on an NPU 428, if present.

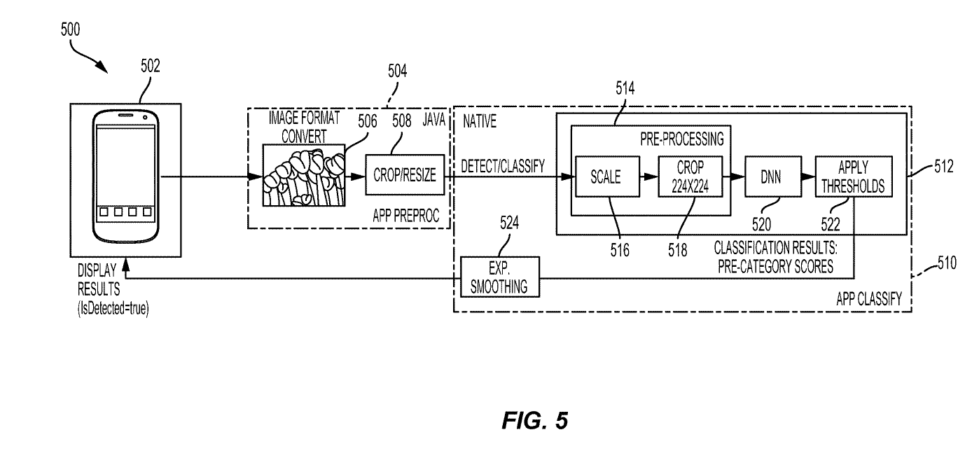

FIG. 5 is a block diagram illustrating the run-time operation 500 of an AI application on a smartphone 502. The AI application may include a pre-process module 504 that may be configured (using for example, the JAVA programming language) to convert the format of an image 506 and then crop and/or resize the image 508. The pre-processed image may then be communicated to a classify application 510 that contains a SceneDetect Backend Engine 512 that may be configured (using for example, the C programming language) to detect and classify scenes based on visual input. The SceneDetect Backend Engine 512 may be configured to further preprocess 514 the image by scaling 516 and cropping 518. For example, the image may be scaled and cropped so that the resulting image is 224 pixels by 224 pixels. These dimensions may map to the input dimensions of a neural network. The neural network may be configured by a deep neural network block 520 to cause various processing blocks of the SOC 100 to further process the image pixels with a deep neural network. The results of the deep neural network may then be thresholded 522 and passed through an exponential smoothing block 524 in the classify application 510. The smoothed results may then cause a change of the settings and/or the display of the smartphone 502.

### Scale Factors and Threshold Selections for Classification

Aspects of the present disclosure are directed to the classification of media, and in particular, for labeling media files, including picture files. Aspects are directed to binary and multi-label classification. In particular, in an illustrative example, three separate sample images contain different colored soccer balls. A first image contains only blue soccer balls, a second image contains only green soccer balls and a third image contains only red soccer balls. Each image may be labeled based on the color of the soccer balls in the image. This process of assigning labels is called classification. In another case, a single image contains soccer balls of several colors. For the same task, the image is labeled with multiple colors. This is called multi-label classification.

In machine learning, classifiers provide a score for each label and a decision function. The decision function checks whether the score is above a certain threshold value. For single-label classifiers, scores of all the labels are considered to determine which label is correct.

For multi-label classification, each label can be correct regardless of the scores of the other labels. Therefore, the thresholds are critical to determine which labels belong to an object. Working with classifiers that output false-positives with very high scores or false-negatives with very low scores makes the problem of finding the right threshold difficult. Aspects of the present disclosure are directed to improving the scale factors and threshold selections for classification.

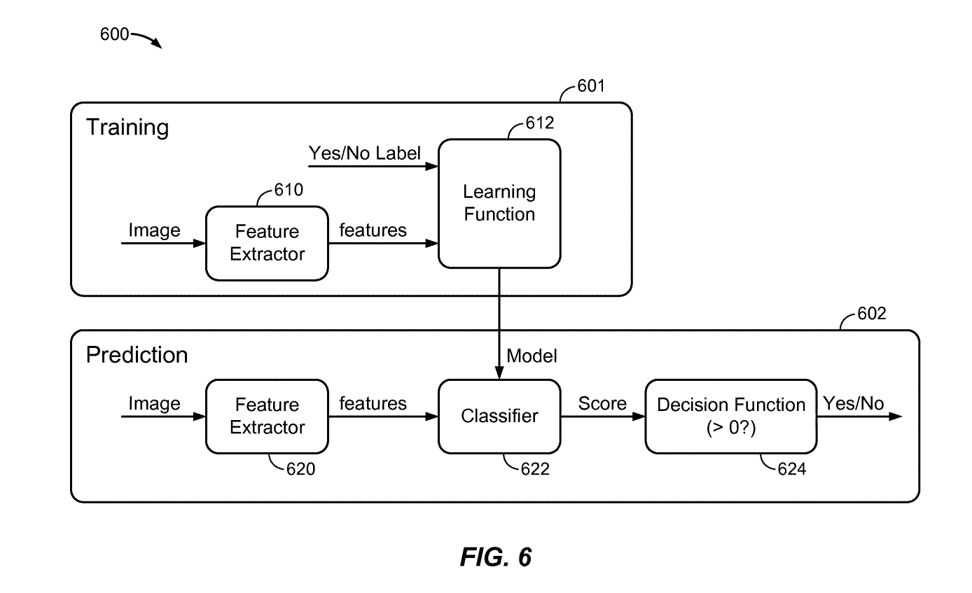

FIG. 6 is an example flow diagram 600 illustrating a binary classification process. In one example, the classification process includes a training phase 601 and a prediction phase 602. In the training phase 601, images are input into a feature extractor 610. Those skilled in the art will appreciate any types of multi-media files, including sounds or images, may be input into the feature extractor. In this illustrative example, each image is passed through a feature extractor 610 to obtain the features and classification of the image. In this example, a binary classification of the image is obtained. The binary classification may be a positive or negative response. Alternately, the output may be a “yes” or “no” label. The learning function 612 learns features for a specific concept or element of training.

Next, in the prediction phase 602, the image is passed through a feature extractor 620. The features are fed to a classifier 622, and based on the learning model utilized by the learning function 612, the classifier 622 outputs a score. A decision function 624 receives the score. In one aspect, the decision function 624 determines whether the score is greater than or less than zero. When the score is greater than zero, and the threshold is zero (or no threshold), the output is a “yes.” Otherwise, the output is a “no.” The decision function may be based on a global threshold utilized by the binary classifier (e.g., zero).

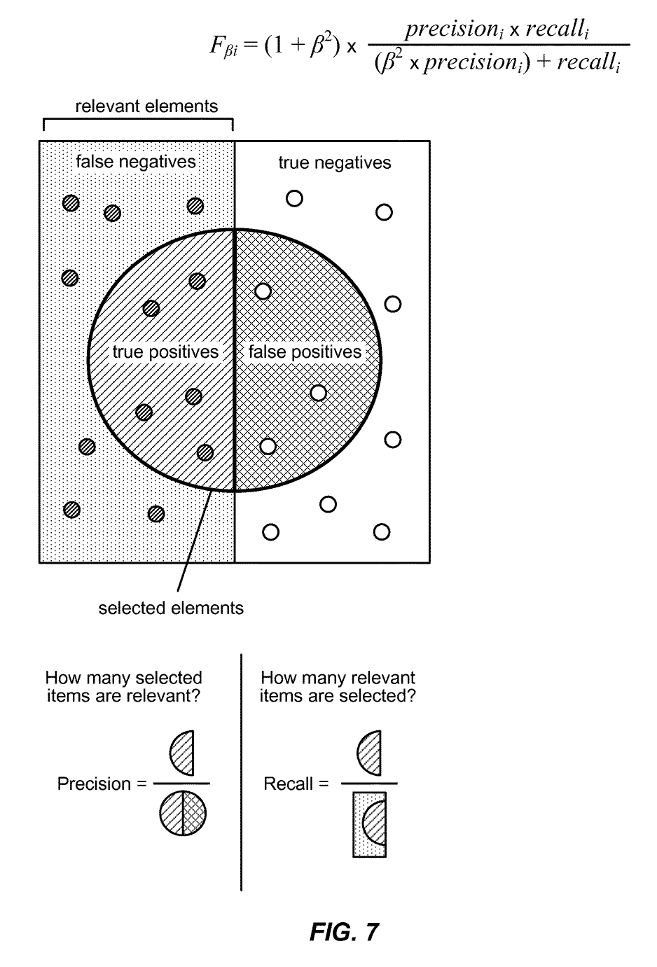

Additional criteria, such as precision and recall, may be utilized in determining the performance of the classifiers. Precision is the number of true positives (e.g., the number of items correctly labeled as belonging to the positive class) divided by the total number of elements labeled as belonging to the positive class (e.g., the sum of true positives and false positives, which are items incorrectly labeled as belonging to the class). Recall is the number of true positives divided by the total number of elements that actually belong to the positive class (e.g., the sum of true positives and false negatives, which are items that were not labeled as belonging to the positive class but should have been). FIG. 7 illustrates the concepts of precision and recall and an F measure equation (which is based on precision and recall).

The following is an illustrative example of media classification. A machine is configured to perform the task of labeling soccer balls in sample images. In particular, the machine utilizes a classifier that takes, as input, the image and outputs the list of labels (e.g., colors) for the image. In this example, the machine is given three images with blue balls, three images with green balls and four images with red balls. The classifier outputs the label ‘red’ to only two of the images that had red balls and mistakenly to an image that had green balls. Precision is the number of images that were labeled ‘red’ correctly divided by the total number of images labeled ‘red.’ In this example, the precision for the label ‘red’ is 2/3. Recall is the number of images that were labeled red correctly divided by the total number of images that should have been label ‘red.’ In the previous example, the recall is 2/4=1/2.

The optimum threshold is one where the precision and recall are both one. This rarely happens because false-positives and false-negatives affect the accuracy. The precision and recall are equal when the number of objects assigned to a label is equal to the number of objects that should be assigned to that label. In the previous example, labeling four images as ‘red’ would make the precision and recall equal. Labeling more than four images would most likely decrease the precision because it would be more likely to label a wrong image as red. Labeling less than four images would likely decrease the recall because it would decrease the numerator if a correctly labeled image is removed. Therefore, there is a compromise between precision and recall. In other words, a higher precision is obtained at the expense of recall and vice versa.

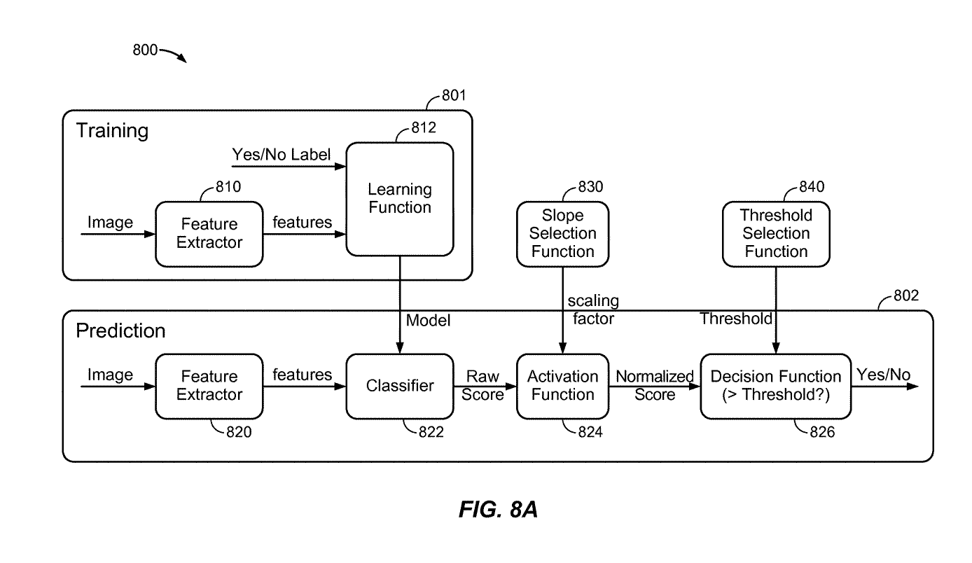

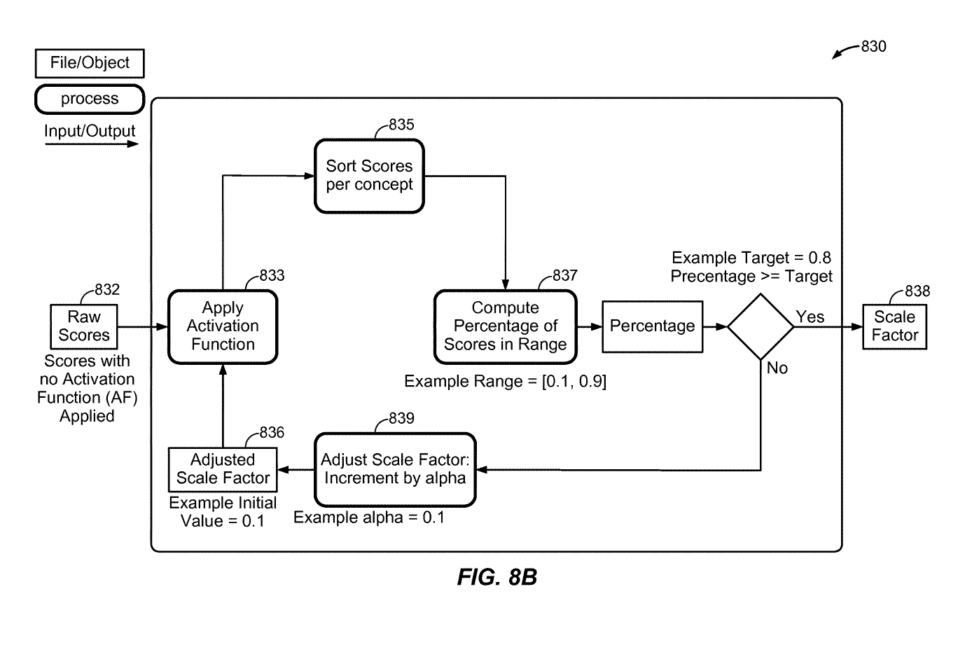

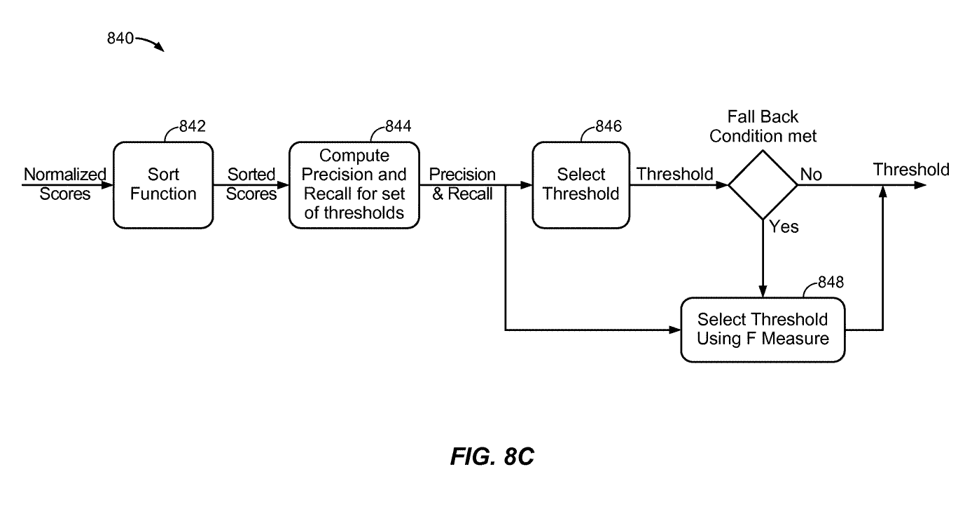

FIG. 8A is a block diagram illustrating an overall example of a classification process 800 according to aspects of the present disclosure. The classification process includes a training phase 801 and a prediction phase 802. In the training phase 801, a feature extractor 810 receives each image and/or media file and outputs the features and binary classification of the received image. The learning function 812 learns particular features for a specific concept or element of training.

In the prediction phase 802, a feature extractor 820 receives each image and outputs features of the image to a classifier 822. Based on the received features and training model, the classifier 822 outputs a raw score to an activation function 824. The activation function 824 normalizes the score to fall within a certain range, for example, the range may be between zero and one, or in the range between one and negative one. Additionally, a slope selection function 830 determines a scaling factor (e.g., a slope) for use by the activation function 824. Various parameters may be changed to affect the factor used by the activation function 824 which will be discussed below. The activation function 824 may be a logistic function, tan-h function or a linear normalization function.

The normalized score output by the activation function 824 is received by a decision function 826. A threshold selection function 840 determines the threshold for use by the decision function 826. In some aspects, the threshold selection function 840 determines a threshold value other than zero. The threshold selection function 840 is discussed in more detail below.

FIG. 8B illustrates an example of the slope selection function 830. The slope selection function 830 uses an image data set to create a list of raw scores for a particular concept/label. To obtain a desirable distribution of scores, the slope selection function 830 determines a scale factor (e.g., a slope). In particular, raw scores 832 from a database of images are supplied. An activation function 833 is applied to the raw score 832. The scores are then sorted at block 835. In one example, the sorted scores are also graphed. The percentage of scores located within a particular range is computed at block 837. Additionally, a target percentage is also established. The target percentage indicates the percent of images located within a certain range of values. Once the target percentage is met, the scale factor 838 is set to the amount that yielded the number of images within the range. For example, if the target percentage is 90%, then once 90% of the images are located within the particular range, the scale factor 838 is set to the value that gave that amount of images in that range.

Additionally, when the target percentage is not met, the scale factor is adjusted. For example, the scale factor may be incrementally adjusted by a value of alpha at block 839. The adjusted scale factor 836 is applied by the activation function at block 833 and the process is repeated. The scale factor is repeatedly incrementally adjusted until the target percentage is achieved. In another aspect, the slope selection function 830 utilizes a target slope instead of a target percentage. For example, a particular slope may be targeted for a range between “a” and “b.” Optionally, in another aspect, rather than incrementing a scale factor, alternate searching functions may be utilized by defining minimum and maximum scale factors. In particular, for example, the scale factor may be adjusted by dividing by two, the difference between a minimum scale factor and a maximum scale factor to determine a new scale factor. In another optional aspect, only range end points are used when iterating through different scaling factors. Additionally, in another aspect, the scale factor may be approximated by using the inverse of the activation function at the range end points.

The threshold selection function 840, as shown in FIG. 8C, may be utilized to adjust a threshold value. Improved accuracy may be observed by adjusting thresholds to a value other than zero. Additionally, tradeoffs between precision and recall may be realized by adjusting the threshold value. For example, the threshold may be adjusted to obtain a desired precision at the expense of recall and vice versa. Additionally, adjusting the threshold removes surrounding values (reflecting objects surrounding the particular object of interest in an image). For example, if an image contains a tree and a chair on a field of grass with a blue sky in the background, then a classifier may be trained to see the tree, grass and sky as common surroundings. Adjusting the threshold removes the surrounding values associated with the tree and grass, thus allowing for a value associated with the chair.

In one aspect, the threshold may be determined by sorting the scores for each label, calculating precision and recall after the sorting and then performing computations to select the threshold. FIG. 8C illustrates an example of the threshold selection function 840, which determines the threshold value. First, for a specific label, the normalized scores for all inputs are obtained. The sort function 842 sorts the normalized scores and may optionally create an ordered list. For example, the scores may be sorted in descending order. Using the sorted list of scores, a computation function 844 computes precision and recall by making each score a threshold. In other words, the precision values and recall values are calculated for each of a corresponding set of candidate threshold values. A threshold may then be selected from the candidate thresholds. The selection may be based, at least in part, on a target precision value and/or a target recall value.

Alternately, rather than using every score, an average of consecutive scores may be used as the set threshold. After computing the precision and recall, a threshold is selected by a selection function 846, based on the precision and recall. The selection function analyzes a combination of the thresholds and associated precision and/or recall values.

Additionally, in another aspect, the threshold may be based on a value corresponding to a maximum F-score. This may occur, for example, when there are no values for which the precision value is above the target precision, when the recall value is above a target recall value, or when a precision or recall is too low when the precision value target is met. Additionally, the threshold may be selected based on the F-score using a beta value that leans towards precision or recall.

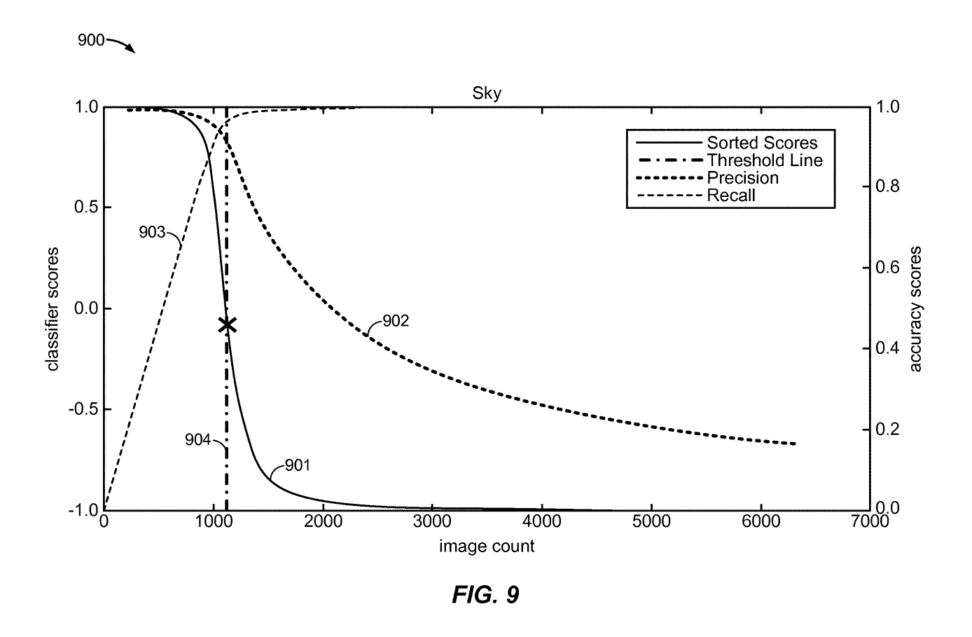

FIG. 9 is a graph 900 illustrating scores for a particular label (e.g., “sky”). The classifier may be trained to learn different concepts in an image. Thousands of images are run through the classifier and the sorted and normalized scores for ‘sky’ are shown at line 901. Each score has a possible value between −1.0 and 1.0. The precision and recall are then calculated and plotted at lines 902 and 903, respectively. The precision line 902 and recall line 903 are on a different scale of 0.0 to 1.0, on the right side of the graph. The line 904 is the threshold line. The line 904 indicates the selected threshold, which is the classifier score at which the dashed line intersects with the sorted scores line 901. Each score along the line 901 may be selected as a candidate threshold and the vertical threshold line (e.g., 904) is analyzed to determine the precision and recall for that candidate threshold.

Various methods may be used to select the threshold, such as, but not limited to, target precision and maximum F measure. For example, in target precision, the score with a precision just above the target precision is selected. For example, the threshold may be selected by targeting a precision of 90%.

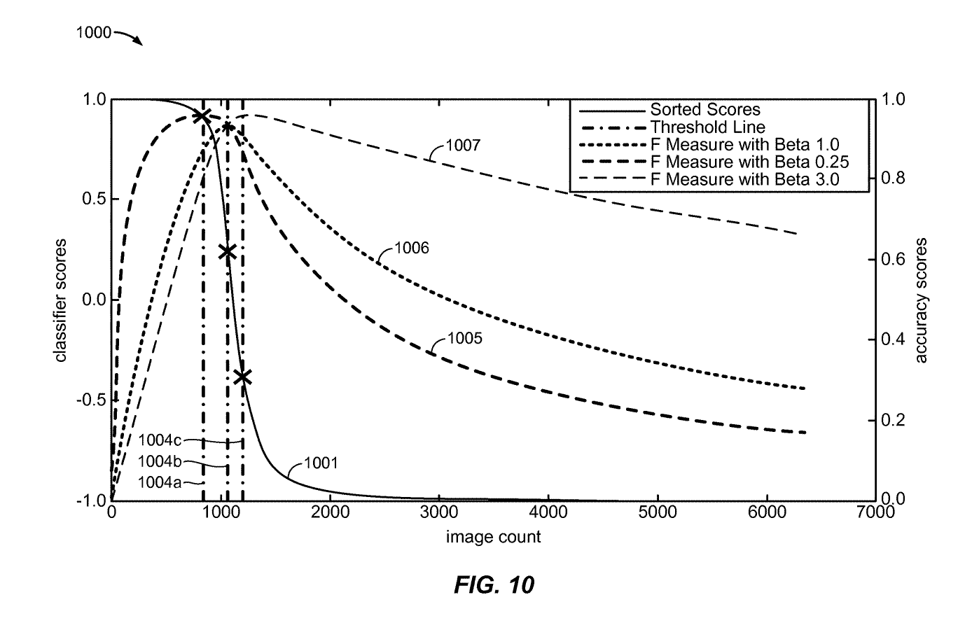

In some scenarios, the threshold may not meet a target percentage and a fall back method is utilized. For example, the F measure function 848 of FIG. 8C may utilize the F measure equation and select a threshold based on a value corresponding to a maximum F-score. The F measure equation is as follows:

$${F}_{β i} = ( 1 + {β}^{2} ) \times \frac{{precision}_{i} \times {recall}_{i}}{( {β}^{2} \times {precision}_{i} ) + {recall}_{i}} , \qquad [ 1 ]$$

where i is the image count. The argmax(F_{β}) is computed to determine the index to the list of scores. The score at this location is the threshold. The beta (β) parameter provides a way of leaning towards recall or precision. When beta is greater than one (β>1), more emphasis is placed on recall. Adjusting the F measure provides feedback on the precision and/or recall. Additionally, the beta value in the F measure equation may be manipulated to affect the precision or recall value. FIG. 10 is a graph 1000 illustrating threshold selection using F measure. Lines 1005, 1006 and 1007 are results of using different beta values for F measure.

Optionally, in an alternate aspect, a bias value is utilized rather than a threshold. In particular, instead of using thresholds, the thresholds may be imbedded into the scores by adding a bias or by normalizing the scores based on the thresholds. Further, in an optional aspect, rather than using the actual scores, per concept scores may be encoded so the scores do not represent the score of each concept.

In one configuration, a model is configured for sorting a set of label scores associated with a first label to create an ordered list. The model is also configured for calculating precision values and recall values corresponding to a set of candidate thresholds from a set of score values (e.g., a plurality of score values). Additionally, the model is configured for selecting a threshold from the candidate thresholds for the first label based on a target precision or a target recall. The model includes a means for sorting, means for calculating, and/or means for selecting. In one aspect, the sorting means, calculating means, and/or selecting means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

In another configuration, a model is configured for sorting a set of label scores associated with a first label to create an ordered list. The model is also configured for calculating a metric of scores within a range and for adjusting the scale factor when the metric of scores are not within the range. The model includes a means for calculating a metric and/or means for adjusting. In one aspect, the metric calculating means and/or adjusting means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

Additionally, the model may also include means for incrementing a scale factor and/or means for dividing. In one aspect, the incrementing means and the dividing means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

According to certain aspects of the present disclosure, each local processing unit 202 may be configured to determine parameters of the network based upon desired one or more functional features of the network, and develop the one or more functional features towards the desired functional features as the determined parameters are further adapted, tuned and updated.

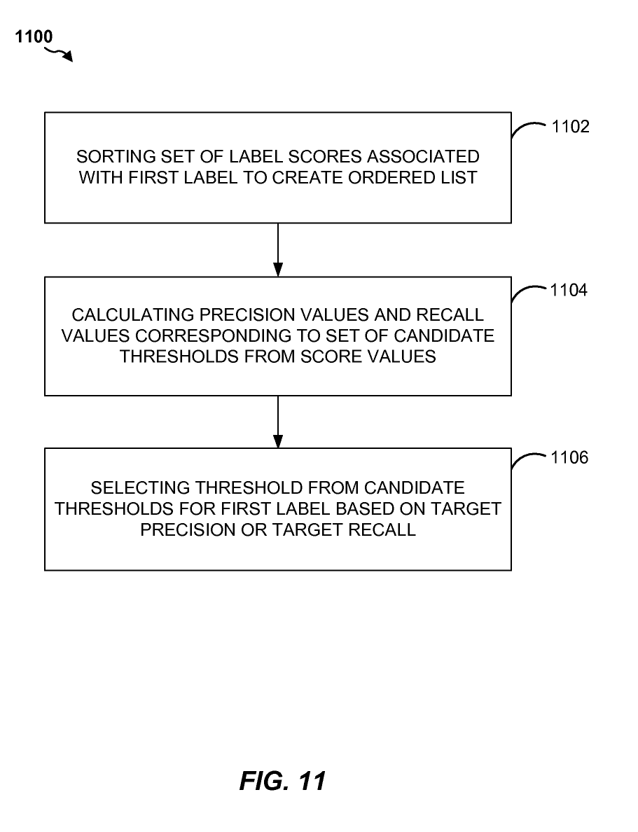

FIG. 11 illustrates a method 1100 for selecting thresholds for multi-label classification. In block 1102, the process sorts a set of label scores associated with a first label to create an ordered list. In block 1104, the process calculates precision values and recall values corresponding to a set of candidate thresholds from a set of score values. Furthermore, in block 1106, the process selects a threshold from the candidate thresholds for the first label based on a target precision or a target recall.

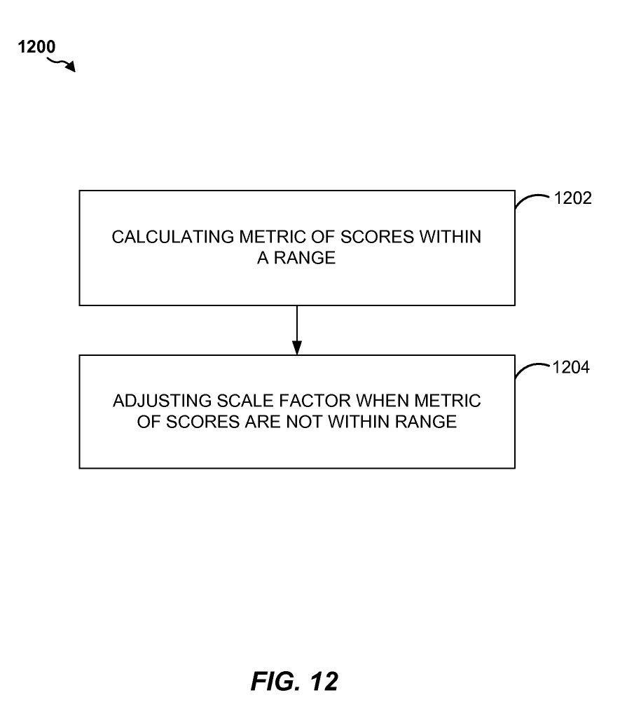

FIG. 12 illustrates a method 1200 for selecting a scale factor for an activation function. In block 1202, the process calculates a metric of scores within a range. In block 1204, the process adjusts the scale factor when the metric of scores are not within the range.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of selecting thresholds for multi-label classification, comprising:
sorting a set of label scores associated with a first label to create an ordered list;
calculating precision values and recall values corresponding to a set of candidate thresholds, from a plurality of score values; and
selecting a threshold from the candidate thresholds for the first label based at least in part on a target precision value or a target recall value.

2. The method of claim 1, in which the threshold is based at least in part on a value corresponding to a maximum F-score when either:
there are no values for which a precision value is above the target precision value or the recall value is above the target recall value, or
the precision value is too low when the target recall value is met or the recall value is too low when the target precision value is met.

3. The method of claim 2, in which the selecting is based at least in part on an F-score using a beta value that leans towards precision or recall.

4. A method of selecting a scale factor for an activation function for multi-label classification, comprising:
calculating a metric of scores within a range; and
adjusting the scale factor when the metric of scores are not within the range.

5. The method of claim 4, in which the activation function comprises a logistic function, tan-h function, or a linear normalization function.

6. The method of claim 4, in which the metric of scores comprises a percentage.

7. The method of claim 4, in which the metric of scores comprises a slope.

8. The method of claim 4, in which adjusting the scale factor comprises one of:
incrementing the scale factor by a value; and
dividing by two a difference between a minimum scale factor and a maximum scale factor.

9. An apparatus for selecting thresholds for multi-label classification in wireless communication, comprising:
a memory; and
at least one processor coupled to the memory, the at least one processor configured:
to sort a set of label scores associated with a first label to create an ordered list;
to calculate precision values and recall values corresponding to a set of candidate thresholds, from a plurality of score values; and
to select a threshold from the candidate thresholds for the first label based at least in part on a target precision value or a target recall value.

10. The apparatus of claim 9, in which the threshold is based at least in part on a value corresponding to a maximum F-score when either:
there are no values for which a precision value is above the target precision value or the recall value is above the target recall value, or
the precision value is too low when the target recall value is met or the recall value is too low when the target precision value is met.

11. The apparatus of claim 10, in which the at least one processor is configured to select based at least in part on an F-score using a beta value that leans towards precision or recall.

12. An apparatus for selecting a scale factor for an activation function in wireless communication, comprising:
a memory; and
at least one processor coupled to the memory, the at least one processor being configured:
to calculate a metric of scores within a range; and
to adjust the scale factor when the metric of scores are not within the range.

13. The apparatus of claim 12, in which the activation function comprises a logistic function, tan-h function, or a linear normalization function.

14. The apparatus of claim 12, in which the metric of scores comprises a percentage.

15. The apparatus of claim 12, in which the metric of scores comprises a slope.

16. The apparatus of claim 12, in which the at least one processor is configured to adjust the scale factor comprises by at least one of:
incrementing the scale factor by a value; and
dividing by two a difference between a minimum scale factor and a maximum scale factor.

17. A non-transitory computer-readable medium for selecting thresholds for multi-label classification, the non-transitory computer-readable medium having non-transitory program code recorded thereon, the program code comprising:
program code to sort a set of label scores associated with a first label to create an ordered list;
program code to calculate precision values and recall values corresponding to a set of candidate thresholds, from a plurality of score values; and
program code to select a threshold from the candidate thresholds for the first label based at least in part on a target precision value or a target recall value.

18. The non-transitory computer-readable medium of claim 17, in which the threshold is based at least in part on a value corresponding to a maximum F-score when either there are no values for which a precision value is above the target precision value or the recall value is above the target recall value, or the precision value is too low when the target recall value is met or the recall value is too low when the target precision value is met.

19. The non-transitory computer-readable medium of claim 18, in which the program code is configured to select based at least in part on an F-score using a beta value that leans towards precision or recall.

20. A non-transitory computer-readable medium for selecting a scale factor for an activation function, the non-transitory computer-readable medium having non-transitory program code recorded thereon, the program code comprising:
program code to calculate a metric of scores within a range; and
program code to adjust the scale factor when the metric of scores are not within the range.

21. The non-transitory computer-readable medium of claim 20, in which the activation function comprises a logistic function, tan-h function, or a linear normalization function.

22. The non-transitory computer-readable medium of claim 20, in which the metric of scores comprises a percentage.

23. The non-transitory computer-readable medium of claim 20, in which the metric of scores comprises a slope.

24. The non-transitory computer-readable medium of claim 20, in which the program code is configured to adjust the scale factor by at least one of:
incrementing the scale factor by a value; and
dividing by two a difference between a minimum scale factor and a maximum scale factor.

25. An apparatus for selecting thresholds for multi-label classification in wireless communication, comprising:
means for sorting a set of label scores associated with a first label to create an ordered list;
means for calculating precision values and recall values corresponding to a set of candidate thresholds, from a plurality of score values; and
means for selecting a threshold from the candidate thresholds for the first label based at least in part on a target precision value or a target recall value.

26. The apparatus of claim 25, in which the threshold is based at least in part on a value corresponding to a maximum F-score when either there are no values for which a precision value is above the target precision value or the recall value is above the target recall value, or the precision value is too low when the target recall value is met or the recall value is too low when the target precision value is met.

27. The apparatus of claim 26, in which the means for selecting is based at least in part on an F-score using a beta value that leans towards precision or recall.

28. A apparatus of selecting a scale factor for an activation function for multi-label classification in wireless communication, comprising:
means for calculating a metric of scores within a range; and
means for adjusting the scale factor when the metric of scores are not within the range.

29. The apparatus of claim 28, in which the activation function comprises a logistic function, tan-h function, or a linear normalization function.

30. The apparatus of claim 28, in which the metric of scores comprises a percentage.

31. The apparatus of claim 28, in which the metric of scores comprises a slope.

32. The apparatus of claim 28, in which the means for adjusting the scale factor comprises one of:
means for incrementing the scale factor by a value; and
means for dividing by two a difference between a minimum scale factor and a maximum scale factor.
